(19) United States
(12) Patent Application Publication
(10) Pub. No.: US 2019/0102399 A1
(43) Pub. Date: Apr. 4, 2019

(54) METHOD AND SYSTEM FOR RESOLVING SEARCH QUERIES THAT ARE INCLINED TOWARDS SOCIAL ACTIVITIES

(71) Applicant: Jagadeshwar Nomula, Fremont, CA (US)

(72) Inventor: Jagadeshwar Nomula, Fremont, CA (US)

(21) Appl. No.: 15/939,270

(22) Filed: Mar. 28, 2018

Related U.S. Application Data
(63) Continuation of application No. 15/709,476, filed on Sep. 20, 2017, now abandoned.
Application No. 15/709,476 is a continuation of application No. 13/208,338, filed on Aug. 12, 2011, now abandoned.

(51) Int. Cl. G06F 17/30

(52) U.S. Cl. CPC G06F 17/3064; G06F 17/30864

(57) ABSTRACT

A method and system for resolving search queries that are inclined towards social activities is provided. The method includes identifying phrases that are inclined towards social activities and storing such phrases. Further, search queries from users are received and search query suggestions are provided based on socially derived information corresponding to at least the user, if the search query comprises at least a part of one of more phrases that are inclined towards social activities.

### CROSS-REFERENCE TO RELATED APPLICATION

This application is a continuation application under 35 U.S.C. § 120 of currently pending U.S. Non-provisional patent application Ser. No. 15/709,476, filed on Sep. 20, 2017, which is a continuation application under 35 U.S.C. § 120 of U.S. Non-provisional patent application Ser. No. 13/208,338, filed on Aug. 12, 2011, now abandoned. The entire disclosures of all of the aforesaid prior applications are incorporated herein by reference.

### FIELD

This application relates generally to the field of internet search engine technology and, more particularly but not exclusively, to resolving search queries that may be inclined towards social activities.

### DISCUSSION OF RELATED FIELD

Over the years, the amount of information available over the internet has grown rapidly. Increased growth in the amount of information and development in internet and related technologies have led to increased dependency of users on the internet to cater to their various requirements. While internet paves the way to a wealth of information, discovering relevant information over the internet is a challenging task.

Several internet search engines attempt to facilitate discovering relevant information over the internet. These search engines rely on various methodologies to identify web pages that might be most relevant to the user, in light of the search query provided by the user to the search engine. In addition to facilitating discovery of relevant information, search engines also attempt to help users in selecting search queries.

Search engines apply various techniques to help users in selecting search queries. One of techniques used for helping users in selecting search queries is by considering the Internet Protocol (IP) address of a data processing system (Ex: computer) from where the search query is origination. A search engine may determine the location of the user querying the search engine by using the IP address of the computer from where the search query is originating. Thereafter, the search engine may suggest search queries based on the location of the computer. For example, as the user in san Francisco types “dining” in the search box, the search engine can give “dining in San Francisco”, “dining in San Mateo” as query suggestions using standard Ajax query technologies. While such suggestions might be useful, dining being a social activity, a query suggestion, such as, “dining thai food” based on the social information corresponding to the user might be even more useful. Further, a query suggestion that is customized to the user querying the search engine will also be useful.

Another technique used for helping users in selecting search queries, in addition to using IP address or otherwise, is by considering the popularity of search queries to provide search query suggestion. For example, when a user types “gifts” as a search query, the search engine might provide a list of query suggestions, such as, “gifts for men”, gifts for wedding” and “birthday gifts”, among others. Such suggestions might be derived based on popularity of queries that other users enter into the search engines having keyword “gifts”. The search engine might use popular searches from other users, couple it with a ranking algorithm and present auto-suggestions “gifts for men”, or “gifts for wedding” for keyword “gifts”. Hence, most users who provide “gifts” as a search query, will be provided with similar query suggestion based on the social information corresponding to the user might be even more useful. Further, a query auto suggestion that is customized to the user querying the search engine will also be useful. Furthermore, providing customized search results for such customized search queries can make the search process more efficient.

In light of the foregoing discussion, there is a need for a technique to suggest and resolve search queries that may be inclined towards social activities, such as gifting, dining, travelling etc.

### SUMMARY

Summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In one aspect a method for resolving search queries that are inclined towards social activities is provided. The method includes identifying phrases that are inclined towards social activities and storing such phrases. Further, search queries from users are received and search query suggestions are provided based on socially derived information corresponding to at least the user, if the search query comprises at least a part of one of more phrases that are inclined towards social activities.

In another aspect a system for resolving search queries that are inclined towards social activities, the system includes a social search phrase identification module, a social query directory and a social search query suggestion module. The social search phrase identification module is configured to identify phrases that are inclined towards social activities. The social query directory is configured to store the identified phrases that are inclined towards social activities, and the social search query suggestion module is configured to provide search query suggestion based on socially derived information corresponding to at least the user, if the search query comprises at least a part of one of more phrases that are inclined towards social activities.

These and other advantages of the present invention will be clarified in the description of the embodiments taken together with the attached drawings in which like reference numerals represent like elements throughout.

### BRIEF DESCRIPTION OF DRAWINGS

Embodiments are illustrated by way of example and not limitation in the Figures of the accompanying drawings, in which like references indicate similar elements and in which:

FIG. 1a is a block diagram illustrating a system 100 configured to resolve search queries that may be inclined towards social activities, in accordance with an embodiment;

FIG. 1b is a block diagram illustrating a system 100 configured to resolve search queries that may be inclined towards social activities, in accordance with an embodiment; and

FIG. 2 is a flow chart illustrating a method for identifying social search phrases, which may be inclined towards social activities, in accordance with an embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Users, to discover relevant information that is available on the internet, use internet search engines extensively. A user can provide a search query to a search engine, and analyze the results that are retrieved by the search engine. The search query provided by the user, as is obvious, depends on the subject of the user's interest. Among the search queries provided by the user, some of the search queries can be classified as being inclined towards social activities. For example, a query, such as “gifts” can be considered as a search query that is inclined towards social activities, as you give gifts to your friends in your social network Similarly, a query, such as “jobs” can be considered as a search query that is inclined towards social activities, because you are potentially looking for a job wherein your acquaintance in your social network is working or has worked

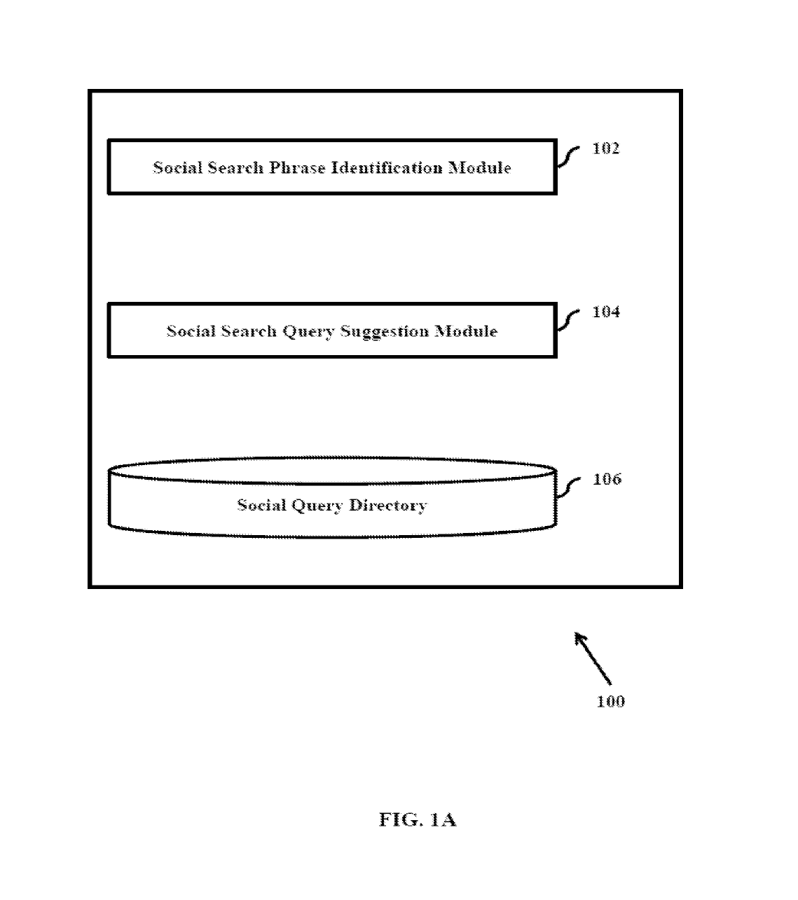

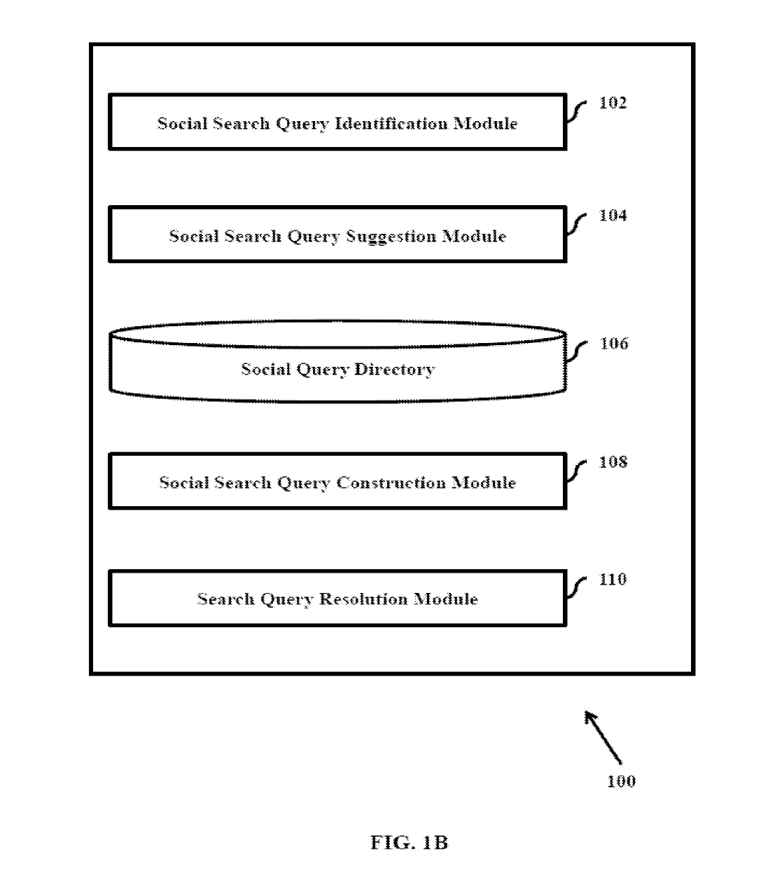

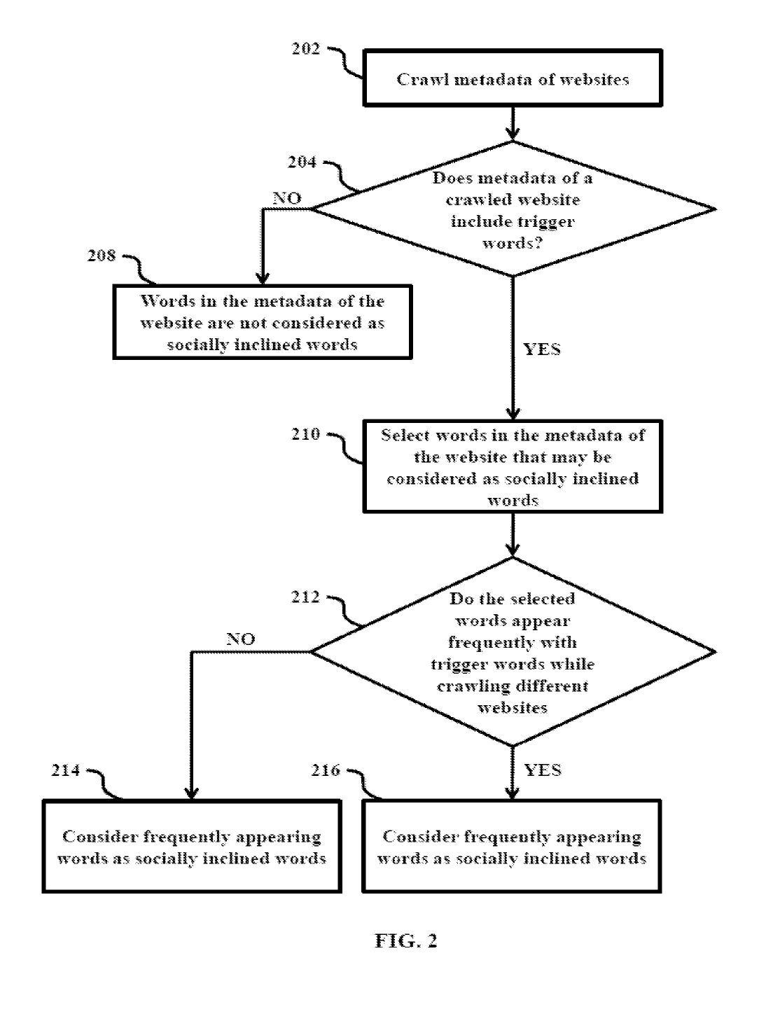

Referring to FIG. 1a to FIG. 2, wherein FIG. 1a is a block diagram illustrating a system 100 configured to resolve search queries that may be inclined towards social activities, in accordance with an embodiment. The system 100 includes Social Search Phrase Identification Module (SSPIM) 102, Social Search Query Suggestion Module (SSQSM) 104 and Social Query Directory (SQD) 106.

SSPIM 102 is configured to identify phrases, which may be inclined towards social activities. In an embodiment, SSPIM 102 is configured to identify phrases, which may be inclined towards social activities, by using crawler hints in metadata or description provided in websites. As the SSPIM 102 crawls through the metadata or description in websites, the SSPIM 102 may crawl content, such as, “give gifts to your facebook friends using gift recommendation utility”. Subsequent to crawling such content, the SSPIM 102 considers the words or phrases present in the crawled content to be recognized as phrases that are inclined towards a social activity, as such phrases appear in the vicinity of the name (Ex: facebook) of a social networking website. The web crawler crawls metadata of the websites and identifies phrases which are relevant to social activities, such as, gifting, jobs etc. The information stored in metadata of websites is used by SSPIM 102 to identify phrases which are relevant to social activities. It shall be noted that the word, “phrases”, is used for referring to one or more words or phrases.

It shall be noted that, in an embodiment system 100 can be configured to crawl metadata of websites to identify one or more categories to which websites belong. Example of categories can include blog sites, news websites, sports related websites and gaming related websites.

FIG. 2 is a flow chart illustrating a method for identifying social search phrases, which may be inclined towards social activities, in accordance with an embodiment. SSPIM 102 crawls metadata of websites and verifies whether “trigger” word(s) (hereinafter referred to as “trigger words”) are present in metadata of the websites that are being crawled. The trigger words, for example can be names of social networking websites, such as, Facebook, Orkut and LinkedIn. The trigger words, for example, can also include words, such as, suggestion, recommendation, and their synonyms and semantic variants. The SSPIM 102 can be provided with instructions to verify whether metadata of a website it is crawling includes one or more trigger words. If such trigger words are not present in the metadata of a website, then the SSPIM 102 may ignore the words in the metadata from being considered as a social phrase, at step 208. However, if at step 204, the SSPIM 102 identifies presence of one or more trigger words in the metadata of the website, then words in the metadata of the website are taken into account for being considered as a social phrase. Further, at step 212, SSPIM 102 checks if the selected words are repeated frequently in metadata of websites that include trigger words. If the selected words appear frequently, then such frequently occurring words are considered as social phrases, at step 216. Alternatively, if such selected words do not appear frequently enough, then such words are not considered as social phrases.

It shall be noted, in an embodiment, the frequency of occurrence of the words selected at step 210, to be considered as social phrases, can be configured in system 100.

In an embodiment, SSPIM 102, in addition to using crawler hints or exclusively, can be configured to analyze users' search sessions to determine phrases that may be inclined towards social activities. For example, SSPIM 102 analyzes the click throughs of users of search results for search queries to determine the frequency of the users landing on a website, which uses social networking information to cater to its visitors. If the signal between the search queries and social networks is strong enough, then system 100 would identify that each of the keywords and sequence of keywords in the search query to be a social phrase. In an embodiment, the signal is a score of affinity of web page to social networks. In an embodiment, the affinity score is determined by a scoring function, such as, cosine similarity or jacardi similarity analysing meta, title tags of the landing site looking for keywords associated with social network, such as, facebook, linkedin, google plus associated with social network features.

The phrases that are inclined towards social activities, which are identified by the SSPIM 102 are stored in the SQD 106. It shall be noted that, in addition to the keywords identified by the SSPIM 102, human editors can update SQD 106 with phrases, which are inclined towards social activities, such as, for example, jobs and gifts.

The SSQSM 104 uses the data stored in SQD 106 to provide suggestions to search queries provided by users. It shall be noted that after receiving a search query from a user, web search server queries various modules to provide auto suggestion, and one among them is SSQSM 104. When a user inputs a search query, the SSQSM 104 checks whether one or more keywords included in the search query is present in the SQD 106. If one or more keywords included in the search query are present in the SQD 106, then the SSQSM 104 provides search query suggestion to the user by using social information corresponding to, the user or the user's social networking connections. The SSQSM 104, based on the context of the search query provided by the user, processes corresponding social information to provide search query suggestions. SSQSM would also get the socially derived information for certain queries. For example, for all career related queries, knowing the companies where friends work is a good social derived information to start with. This social derived information can be extracted (after receiving appropriate permissions) by either calling social network API for each of his friends information or deriving the information by analyzing friends previous search queries on the search engine and following through his behaviour across multiple sites on the internet, or using the client side cookies (cookies stored on browser)/server side cookies (Browser Cookies copied onto to server for inter-relating behaviour across multiple sites).

In an embodiment, to provide auto suggestion, synonyms of social phrases are derived. The derived synonyms are used to identify appropriate social feeds that have to be considered to provide autosuggestion. For example, for social phrase, such as, jobs, social feeds corresponding to, for example, jobs and careers, are used to provide autosuggestion.

In an embodiment, in addition to using the above methodology, or exclusively, word in meta tag of websites from which social phrases are derived, are used for determining the social feeds which have to be considered for providing autosuggestion. For example, for providing autosuggestion for keyword “job” entered in search box, system 100 provides the companies the friends are working in, at the top of auto suggestion. In this example, the system 100 considers “companies” as the appropriate tag that has to be looked in social feed, based on the information aggregated from meta tags, as websites had “Job Recommendations in Companies where your friends work” or “Jobs in companies in your linkedin network”.

In another embodiment, in addition to the one or more of the above strategies, or exclusively, one can manually configure using web application, to consider feeds corresponding to “companies” when a search query includes the keyword “job”.

In another example, when a user types “gift” into the search box, system 100 analyses social feeds corresponding to the user's social networking friends to determine whose birth day is close, as a possible auto suggestion.

Further, it shall be noted that after a web search server receives suggestion from SSQSM 104 and various other suggestion modules, the web search server aggregates and ranks the auto search-suggestion results for presenting the same to the user.

In an embodiment, the system 100, in addition to including SSPIM 102, SSQSM 104 and SQD 106, also includes Social Search Query Construction Module (SSQCM) 108 and Search Query Resolution Module (SQRM) 110. The SSQCM 108 and SQRM 110 facilitates retrieving search results to the user. In an embodiment, the search query provided by the user, which might have been selected from the suggestion provided by the SSQSM 104, is used by the SSQCM 108 to construct a search query. SSQCM 108 constructs a query model based on selected search query. This search query constructed by the SSQCM 108 is used for retrieving search results that are displayed to the user. The SSQCM 108 is configured to use social information corresponding to, the user or the user's social networking connections, for constructing a search query. For example, the SSQCM 108 can use social information, such as, social feeds, location, likes, age, gender and hobbies, among other information, to construct a search query. The constructed search query is communicated to the SQRM 110.

SQRM 110 is configured to receive constructed search query from SSQCM 108 and retrieve search results, which are displayed to the user. The search results may be displayed in the descending order of relevance. In an embodiment, the SQRM 110 may send at least a part of the constructed query to external application program interface, and retrieve results. Thereafter, additional filters can be applied based on the constructed query to determine the search results (and also relevancy of results), which would be displayed to the user.

In an embodiment, SQRM 110 uses the query modelled by the SSQCM 108 to query one or more index based on the query. After retrieving results from the index, in an embodiment, the SQRM 110 can process the results to rank the results based on, for example, socially derived information of the user or user's social network. For example, when the selected search query includes the word “gift”, the SSQCM 108 constructs a gift model query, which will be used by SQRM 110 to query gifts catalogue index. After getting results from the gifts index, SQRM 110 might process the results to rank the results by taking into account the profile of personality of the person, who is giving gifts. In an embodiment, ranking can be done by tfidf(term frequency inverted document frequency) scoring combined with jcaradi similarity between the query model and results from the SQRM, aggregated by querying different inverted indexes using a linear function.

In an embodiment, SQRM 110 can use query modelled by SSQCM 108 to query an external data provider. For example, when a user selects, “jobs in Microsoft”, the SQRM 110 would give a call to external data provider, such as, monster.com, to provider results for “software jobs in microsoft”, where-in “software” attribute could have been extracted by analysing the user profile and his previous searches, and displays the results. In another embodiment, the SQRM 110 would have all the job openings in its reverse search index. The SQRM 110 would then show the results of jobs in microsoft as well as other search results in conjunction, as a response for the “jobs in Microsoft” selection. The SQRM 110 can also add information about his friends in the social network who can help with job search as part of search results.

The processes described above and illustrated in the drawings is shown as a sequence of steps, this was done solely for the sake of illustration. Accordingly, it is contemplated that some steps may be added, some steps may be omitted, the order of the steps may be re-arranged, and/or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A method for resolving search queries that are inclined towards social activities, the method comprising:
identifying phrases that are inclined towards social activities;
receiving search query from a user; and
providing search query suggestion based on socially derived information corresponding to at least the user, if the search query comprises at least a part of one of more phrases that are inclined towards social activities.
